(19) United States
(12) Patent Application Publication
(10) Pub. No.: US 2020/0091802 A1
(43) Pub. Date: Mar. 19, 2020

(54) METHOD OF MANUFACTURING ROTOR CORE

(71) Applicant: Mitsui High-tec, Inc., Kitakyushu-shi (JP)

(72) Inventor: Kohei YOSHIDA, Kitakyushu-shi (JP)

(73) Assignee: Mitsui High-tec, Inc., Kitakyushu-shi (JP)

(21) Appl. No.: 16/690,134

(22) Filed: Nov. 21, 2019

Related U.S. Application Data
(63) Continuation of application No. PCT/JP2018/010261, filed on Mar. 15, 2018.

(30) Foreign Application Priority Data
May 25, 2017 (JP) 2017-103579

(51) Int. Cl. H02K 15/16; H02K 15/03

(52) U.S. Cl. CPC H02K 15/165; H02K 15/03

(57) ABSTRACT

A method of manufacturing a rotor core includes: acquiring individual weights of a plurality of permanent magnets to identify heavier permanent magnets and lighter permanent magnets based on a comparison of the individual weights; obtaining first to N^{th} magnet sets by combining at least one of the heavier permanent magnets and at least one of the lighter permanent magnets into each magnet set, wherein N is a natural number equal to or greater than 2; preparing a core body configured to rotate around a predetermined rotational axis, the core body including first to N^{th} attaching locations arranged in a circumferential direction of the rotational axis; and attaching each of the first to N^{th} magnet sets to a different oneof the first to N^{th} attaching locations.

### CROSS-REFERENCE TO RELATED APPLICATIONS

This application is a continuation application of PCT Application No. PCT/JP2018/010261 filed on Mar. 15, 2018, which claims the benefit of priority from Japanese Patent Application No. 2017-103579, filed on May 25, 2017, the entire contents of which are incorporated herein by reference.

### FIELD

The present disclosure relates to a method of manufacturing a rotor core.

### BACKGROUND

Japanese Unexamined Patent Publication No. 2016-092994 discloses a rotor core for use in a surface permanent magnet (SPM) motor. The rotor core includes a core body and a plurality of permanent magnets attached to the outer peripheral surface of the core body.

Japanese Unexamined Patent Publication No. 2013-009453 discloses a rotor core for use in an interior permanent magnet (IPM) motor. The rotor core includes a core body having a plurality of insertion holes extending in the rotational axis direction and a plurality of permanent magnets inserted in the insertion holes.

### SUMMARY

A method of manufacturing a rotor core according to an aspect of the present disclosure includes: acquiring weights of a plurality of permanent magnets individually; obtaining first to N^{th} (N is a natural number equal to or greater than 2) magnet sets by combining at least one relatively heavy permanent magnet and at least one relatively light permanent magnet of the permanent magnets into one magnet set, based on the acquired individual weights of the permanent magnets; preparing a core body configured to rotate around a predetermined rotational axis, the core body having first to N^{th} attaching locations in a row in a circumferential direction of the rotational axis; and attaching the first to N^{th} magnet sets to any of the first to N^{th} attaching locations one by one.

A method of manufacturing a rotor core according to another aspect of the present disclosure includes: acquiring weights of first to L^{th} (L is a natural number equal to or greater than 5) permanent magnets individually; preparing a core body configured to rotate around a predetermined rotational axis, the core body having first to L^{th} attaching locations in a row in a circumferential direction of the rotational axis; and when the acquired weights m₁, m₂, . . . m_{L-1}, m_{L} of the first to L^{th} permanent magnets satisfy Expression (1), attaching the first to L^{th} permanent magnets to the first to L^{th} attaching locations one by one such that a d^{th} (d is a natural number from 2 to L−1) permanent magnet of the first to L^{th} permanent magnets is not adjacent to a (d−1)^{th} permanent magnet of the first to L^{th} permanent magnets and a (d+1)^{th} permanent magnet of the first to L^{th} permanent magnets in the circumferential direction of the rotational axis.

m₁≥m₂≥ . . . m_{L-1}≥m_{L} (1)

A method of manufacturing a rotor core according to another aspect of the present disclosure includes: acquiring weights of first to K^{th} (K is an even number equal to or greater than 4) permanent magnets individually; preparing a core body configured to rotate around a predetermined rotational axis, the core body having first to K^{th} attaching locations in a row in a circumferential direction of the rotational axis; and when the acquired weights m₁, m₂, . . . m_{K-1}, m_{K} of the first to K^{th} permanent magnets satisfy Expression (2), attaching the first to K^{th} permanent magnets to the first to K^{th} attaching locations one by one such that an e^{th} (e is an odd number from 1 to K) permanent magnet of the first to K^{th} permanent magnets and an f^{th} (f is an even number that satisfies f=e+1 and from 1 to K) permanent magnet of the first to K^{th} permanent magnets face each other with the rotational axis interposed therebetween.

m₁≥m₂≥ . . . m_{K-1}≥m_{K} (1)

A method of manufacturing a rotor core according to another aspect of the present disclosure includes: acquiring weights of first to J^{th} (J is an even number equal to or greater than 6) permanent magnets individually; preparing a core body configured to rotate around a predetermined rotational axis, the core body having first to J^{th} attaching locations in a row in a circumferential direction of the rotational axis; and when the acquired weights m₁, m₂, . . . m_{J-1}, m_{J} of the first to J^{th} permanent magnets satisfy Expression (3), forming J/2 pairs each by selecting any two permanent magnets from among the first to J^{th} permanent magnets, and attaching the first to J^{th} permanent magnets to the first to J^{th} attaching locations one by one such that relatively heavy permanent magnets of the pairs are not adjacent to each other in the circumferential direction of the rotational axis, relatively light permanent magnets of the pairs are not adjacent to each other in the circumferential direction of the rotational axis, and permanent magnets in each pair face each other with the rotational axis interposed therebetween.

m₁≥m₂≥ . . . m_{J-1}≥m_{J} (3)

### BRIEF DESCRIPTION OF THE DRAWINGS

FIG. 1 is a perspective view illustrating an example of a stacked rotor core.

FIG. 2 is a cross-sectional view along line II-II in FIG. 1.

FIG. 3 is a top view illustrating an example of the stacked rotor core.

FIGS. 4A-4E are schematic diagrams illustrating combinations of magnetic insertion holes and magnet sets.

FIGS. 5A-5D are schematic diagrams illustrating combinations of magnetic insertion holes and magnet sets.

FIG. 6 is a schematic diagram illustrating an example of a manufacturing apparatus for the stacked rotor core.

FIG. 7 is a flowchart for explaining an example method of manufacturing the stacked rotor core.

FIGS. 8A-8B are schematic diagrams illustrating combinations of magnetic insertion holes and magnet sets.

FIG. 9 is a cross-sectional view of another example of the stacked rotor core cut in the same manner as in FIG. 2.

FIG. 10 is a perspective view illustrating another example of a stacked rotor core.

### DETAILED DESCRIPTION

In the following description, with reference to the drawings, the same reference numbers are assigned to the same components or to similar components having the same function, and overlapping description is omitted.

Structure of Stacked Rotor Core

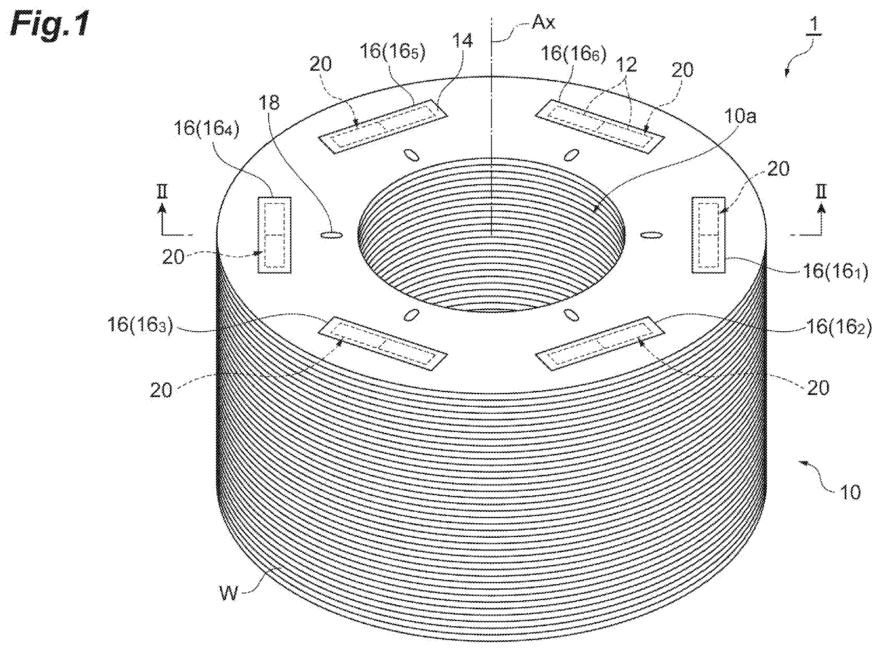

First of all, referring to FIG. 1 to FIG. 3, a structure of a stacked rotor core 1 (rotor core) is described. The stacked rotor core 1 is a part of a rotor. End plates and a shaft are attached to the stacked rotor core 1 to form a rotor. The rotor is combined with a stator to form a motor. The stacked rotor core 1 in the present example is used in an interior permanent magnet (IPM) motor. As illustrated in FIG. 1, the stacked rotor core 1 includes a stack 10 (core body), a plurality of permanent magnets 12, and a plurality of resin materials 14.

As illustrated in FIG. 1, the stack 10 has a cylindrical shape. More specifically, an axial hole 10a passing through the stack 10 so as to extend along the center axis Ax is provided at the center portion of the stack 10. In other words, the axial hole 10a extends in the stacking direction of the stack 10 (which may be referred to as “height direction” of the stack 10). The stacking direction is also the extending direction of the center axis Ax. In the present example, since the stack 10 rotates around the center axis Ax, the center axis Ax is the rotational axis. A shaft is inserted in the axial hole 10a.

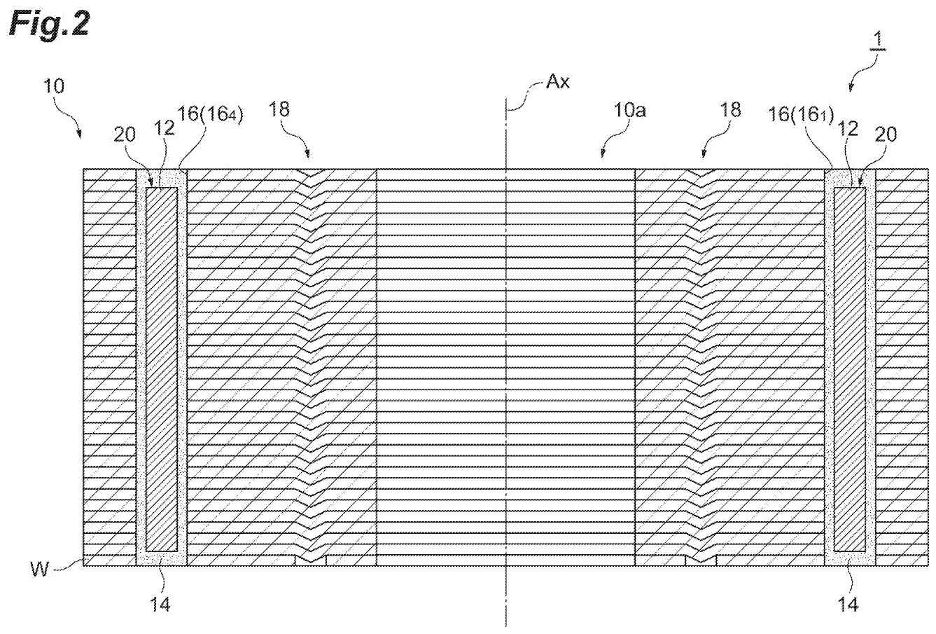

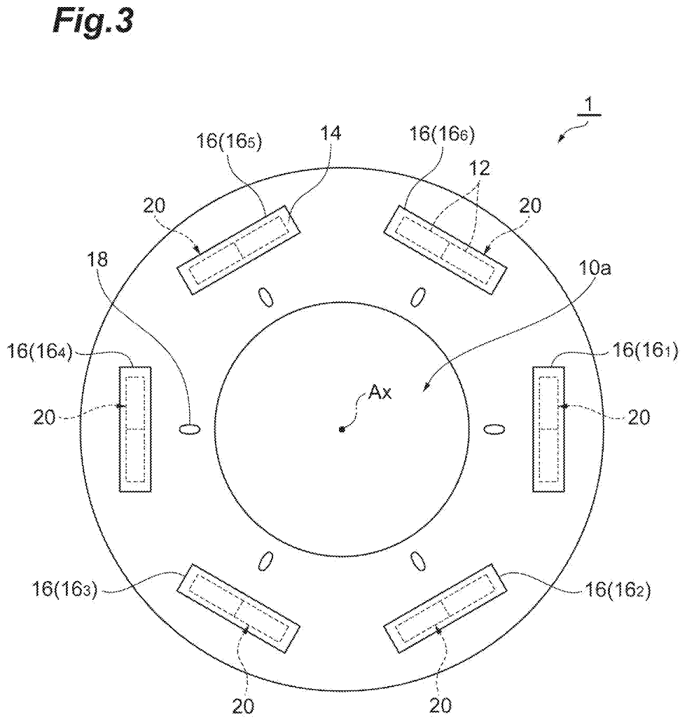

The stack 10 has a plurality of magnet insertion holes 16 (attaching locations). As illustrated in FIG. 1 and FIG. 3, the magnet insertion holes 16 are arranged at regular intervals along the outer peripheral edge of the stack 10. As illustrated in FIG. 2, the magnet insertion holes 16 each pass through the stack 10 so as to extend along the center axis Ax. That is, the magnet insertion hole 16 extends in the stacking direction.

In the present example, the shape of the magnet insertion hole 16 is an elongated hole extending along the outer peripheral edge of the stack 10. There are six magnet insertion holes 16 in the present example. These magnet insertion holes 16 may be hereinafter denoted as magnet insertion holes 16₁ to 16₆. The magnet insertion holes 16₁ to 16₆ are arranged in a row clockwise in this order as viewed from above. The position, the shape, and the number of magnet insertion holes 16 may be changed according to the application of the motor, the required performance, and the like.

The stack 10 is configured such that a plurality of blanked members W are stacked. The blanked member W is a plate-shaped part formed by blanking an electrical steel sheet ES described later into a predetermined shape and has a shape corresponding to the stack 10.

The stack 10 may be configured by rotational stacking. “Rotational stacking” refers to stacking a plurality of blanked members W while shifting the angles of the blanked members W relative to each other. The rotational stacking is performed mainly for cancelling out the plate thickness deviations of the stack 10. The angle of the rotational stacking may be set to a desired value.

As illustrated in FIG. 1 to FIG. 3, the blanked members W adjacent in the stacking direction may be fastened to each other by connecting tab portions 18. These blanked members W may be fastened to each other by a variety of known methods instead of the connecting tab portions 18. For example, a plurality of blanked members W may be joined to each other by adhesive or resin material or joined to each other by welding. Alternatively, the blanked member W may be provided with a temporarily-connecting tab, and the stack 10 may be obtained by fastening a plurality of blanked members W to each other through the temporarily-connecting tabs and thereafter removing the temporarily-connecting tabs from the stack. The “temporarily-connecting tab” means a connecting tab used for temporarily integrating a plurality of blanked member W and removed in the process of producing a product (stacked rotor core 1).

As illustrated in FIG. 1 to FIG. 3, the permanent magnet 12 is inserted in the magnet insertion hole 16. Specifically, in the present example, one magnet set 20 that is a combination of two permanent magnets 12 is inserted in one magnet insertion hole 16. In the present example, 12 permanent magnets 12 are combined two by two to form six magnet sets 20₁ to 20₆, and one of the magnet sets 20₁ to 20₆ is inserted in the corresponding one of six magnet insertion holes 16₁ to 16₆. In each magnet insertion hole 16, two permanent magnets 12 are arranged adjacent to each other in the longitudinal direction of the magnet insertion hole 16 the circumferential direction of the stack 10). The permanent magnet 12 has the shape of, but not limited to, a rectangular parallelepiped in the present example. The kind of permanent magnets 12 is determined according to the application of the motor, the required performance, and the like and may be, for example, sintered magnets or bonded magnets. The weights of the permanent magnets 12 vary, for example, on the order of a few grams due to manufacturing error.

The magnet insertion hole 16 is filled with the resin material 14 after the permanent magnet 12 (magnet set 20) is inserted. The resin material 14 has the function of fixing the permanent magnet 12 (magnet set 20) in the magnet insertion hole 16. An example of the resin material 14 is a thermosetting resin. A specific example of the thermosetting resin is a resin composition including an epoxy resin, a cure initiator, and an additive. Examples of the, additive include filler, fire retardant, and stress reducer. The resin material 14 also has the function of joining the blanked members W adjacent in the top-down direction together. A thermoplastic resin may be used as the resin material 14.

Detail of Magnet Set

The detail of the magnet set 20 will now be described. In the present example, the magnet set 20 is configured not with a combination of arbitrary two permanent magnets 12 but with a combination of two permanent magnets 12 that satisfy a predetermined condition. Specifically, when the weights m₁ to m₁₂ of 12 permanent magnets 12₁ to 12₁₂ satisfy Expression (4), one of relatively heavy permanent magnets 12₁ to 12₆ and one of relatively light permanent magnets 12₇ to 12₁₂ may be combined into one magnet set 20 (Condition 1).

m₁≥m₂≥ . . . m₁₁≥m₁₂ (4)

Alternatively, when the weights m₁ to m₁₂ of 12 permanent magnets 12₁ to 12₁₂ satisfy Expression (4), each of magnet sets 20₁ to 20₆ may be a combination as follows (Condition 2).

Magnet set 20₁: combination of permanent magnet 12₁ (weight m₁) and permanent magnet 12₁₂ (weight m₁₂)

Magnet set 20₂: combination of permanent magnet 12₂ (weight m₂) and permanent magnet 12₁₁ (weight m₁₁)

Magnet set 20₃: combination of permanent magnet 12₃ (weight m₃) and permanent magnet 12₁₀ (weight m₁₀)

Magnet set 20₄: combination of permanent magnet 12₄ (weight m₄) and permanent magnet 12₉ (weight m₉)

Magnet set 20₅: combination of permanent magnet 12₅ (weight m₅) and permanent magnet 12₈ (weight m₈)

Magnet set 20₆: combination of permanent magnet 12₆ (weight m₆) and permanent magnet 12₇ (weight m₇)

That is, magnet sets 20₁ to 20₆ may be obtained by repeating the procedure of combining one heaviest permanent magnet 12₁ and one lightest permanent magnet 12₁₂ of 12 permanent magnets 12₁ to 12₁₂ to obtain one magnet set 20₁ and combining one heaviest permanent magnet 12₂ and one lightest permanent magnet 12₁₁ of the remaining 10 permanent magnets 12₂ to 12₁₁ to obtain one magnet set 20₂.

When the weights M₁ to M₆ of magnet sets 20₁ to 20₆ satisfy Expression (5), these magnet sets 20₁ to 20₆ may be inserted one by one in any magnet insertion holes 16₁ to 16₆ (Condition 3).

M₁≥M₂≥M₃≥M₄≥M₅≥M₆ (5)

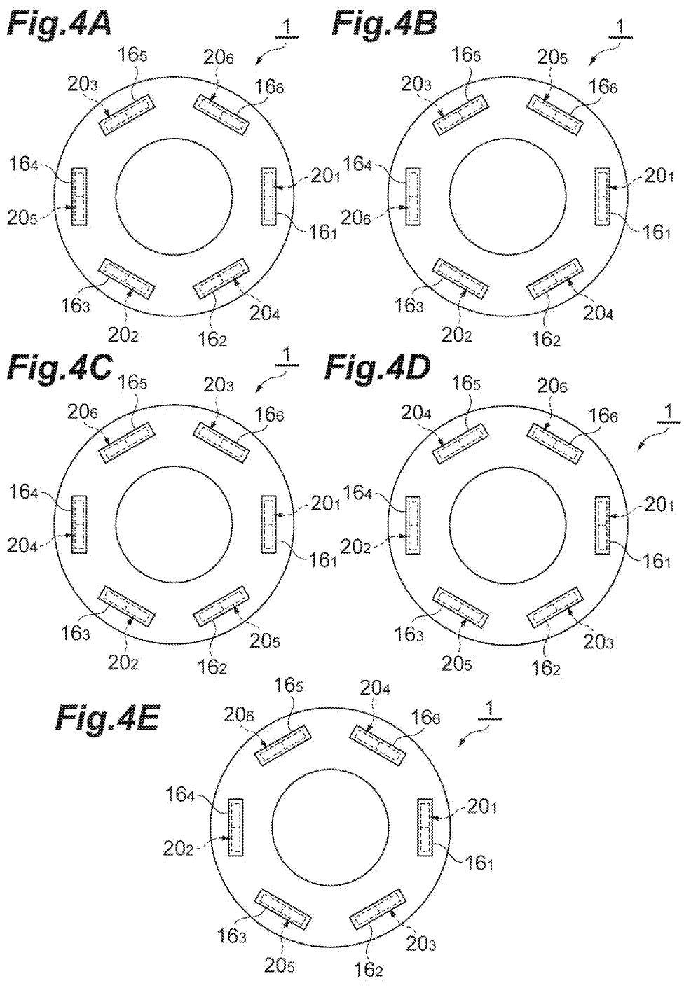

Alternatively, when the weights M₁ to M₆ of magnet sets 20₁ to 20₆ satisfy Expression (5), the magnet sets 20₁ to 20₆ may be inserted in the magnet insertion holes 16₁ to 16₆ one by one such that a magnet set 20, (a is a natural number from 2 to 5) is not adjacent to a magnet set 20ₐ₋₁ and a magnet set 20ₐ₊₁ in the circumferential direction of the center axis Ax (Condition 4). As illustrated in FIGS. 4A-4E and Table 1, there are five combinations of six magnet insertion holes 16₁ to 16₆ and six magnet sets 20₁ to 20₆ that can satisfy Condition 4, excluding a combination that is the same when the stacked rotor core 1 is turned upside down.

TABLE 1

| | | Magnet insertion hole | | | | | |
|---|---|---|---|---|---|---|---|
| | | 16₁ | 16₂ | 16₃ | 16₄ | 16₅ | 16₆ |
| Combination of magnet sets | FIG. 4A | 20₁ | 20₄ | 20₂ | 20₅ | 20₃ | 20₆ |
| | FIG. 4B | 20₁ | 20₄ | 20₂ | 20₆ | 20₃ | 20₅ |
| | FIG. 4C | 20₁ | 20₅ | 20₂ | 20₄ | 20₆ | 20₃ |
| | FIG. 4D | 20₁ | 20₃ | 20₅ | 20₂ | 20₄ | 20₆ |
| | FIG. 4E | 20₁ | 20₃ | 20₅ | 20₂ | 20₆ | 20₄ |

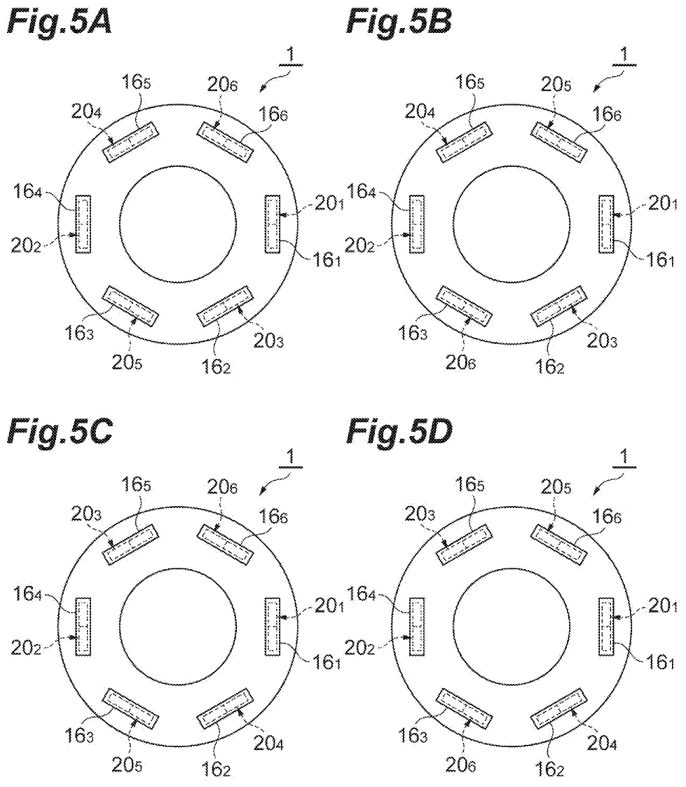

Alternatively, when the weights M₁ to M₆ of magnet sets 20₁ to 20₆ satisfy Expression (5), the magnet sets 20₁ to 20₆ may be inserted in the magnet insertion holes 16₁ to 16₆ one by one such that a magnet set 20_{b} (b is an odd number from 1 to 6) and a magnet set 20_{c} (c is an even number that satisfies c=b+1 and from 1 to 6) face each other with the center axis Ax interposed therebetween (Condition 5). That is, the magnet set 20_{b} and the magnet set 20_{c} may form a pair so as to face each other with the center axis Ax interposed therebetween, and the weights M₁, M₂, . . . M₅, M₆ of the magnet sets 20₁ to 20₆ may decrease in this order. The odd-numbered magnet set 20 of a pair of magnet sets 20 is heavier than the even-numbered magnet set 20 of the respective pair of magnet sets 20. As illustrated in FIGS. 5A-5D and Table 2, there are four combinations of six magnet insertion holes 16₁ to 16₆ and six magnet sets 20₁ to 20₆ that can satisfy Condition 5, excluding a combination that is the same when the stacked rotor core 1 is turned upside down.

TABLE 2

| | | Magnet insertion hole | | | | | |
|---|---|---|---|---|---|---|---|
| | | 16₁ | 16₂ | 16₃ | 16₄ | 16₅ | 16₆ |
| Combination of magnet sets | FIG. 5A | 20₁ | 20₃ | 20₅ | 20₂ | 20₄ | 20₆ |
| | FIG. 5B | 20₁ | 20₃ | 20₆ | 20₂ | 20₄ | 20₅ |
| | FIG. 5C | 20₁ | 20₄ | 20₅ | 20₂ | 20₃ | 20₆ |
| | FIG. 5D | 20₁ | 20₄ | 20₆ | 20₂ | 20₃ | 20₅ |

Alternatively, while Condition 5 is satisfied, odd-numbered magnet sets 20 of the magnet sets 20₁ to 20₆ are not necessarily adjacent to each other in the circumferential direction of the center axis Ax, and even-numbered magnet sets 20 of the magnet sets 20₁ to 20₆ are not necessarily adjacent to each other in the circumferential direction of the center axis Ax (Condition 6). As illustrated in FIG. 5C and Table 2, there is one combination of six magnet insertion holes 16₁ to 16₆ and six magnet sets 20₁ to 20₆ that can satisfy Condition 6, excluding a combination that is the same when the stacked rotor core 1 is turned upside down.

Alternatively, when the weights M₁ to M₆ of magnet sets 20₁ to 20₆ satisfy Expression (5), three pairs may be each formed by selecting any two magnet sets 20 from among the magnet sets 20₁ to 20₆, and the magnet sets 20₁ to 20₆ may be inserted in the magnet insertion holes 16₁ to 16₆ one by one such that relatively heavy magnet sets 20 of the pairs are not adjacent to each other in the circumferential direction of the center axis Ax, relatively light magnet sets 20 of the pairs are not adjacent to each other in the circumferential direction of the center axis Ax, and the magnet sets 20 in each pair face each other with the center axis Ax interposed therebetween (Condition 7). That is, relatively heavy magnet sets 20 of the pairs may be inserted in the magnet insertion holes 16₁, 16₃, and 16₅, and relatively light magnet sets 20 of the pairs may be inserted in the magnet insertion holes 16₂, 16₄, and 16₆. As illustrated below, there are 15 combinations when three pairs are each formed by selecting any two magnet sets 20 from the magnet sets 20₁ to 20₆. In the following, the pairs of magnet sets 20 are delimited by symbols “/”.

1: magnet sets 20₁, 20₂/magnet sets 20₃, 20₄/magnet sets 20₅, 20₆

2: magnet sets 20₁, 20₂/magnet sets 20₃, 20₅/magnet sets 20₄, 20₆

3: magnet sets 20₁, 20₂/magnet sets 20₃, 20₆/magnet sets 20₄, 20₅

4: magnet sets 20₁, 20₃/magnet sets 20₂, 20₄/magnet sets 20₅, 20₆

5: magnet sets 20₁, 20₃/magnet sets 20₂, 20₅/magnet sets 20₄, 20₆

6: magnet sets 20₁, 20₃/magnet sets 20₂, 20₆/magnet sets 20₄, 20₅

7: magnet sets 20₁, 20₄/magnet sets 20₂, 20₃/magnet sets 20₅, 20₆

8: magnet sets 20₁, 20₄/magnet sets 20₂, 20₅/magnet sets 20₃, 20₆

9: magnet sets 20₁, 20₄/magnet sets 20₂, 20₆/magnet sets 20₃, 20₅

10: magnet sets 20₁, 20₅/magnet sets 20₂, 20₃/magnet sets 20₄, 20₆

11: magnet sets 20₁, 20₅/magnet sets 20₂, 20₄/magnet sets 20₃, 20₆

12: magnet sets 20₁, 20₅/magnet sets 20₂, 20₆/magnet sets 20₃, 20₄

13: magnet sets 20₁, 20₆/magnet sets 20₂, 20₃/magnet sets 20₄, 20₅

14: magnet sets 20₁, 20₆/magnet sets 20₂, 20₄/magnet sets 20₃, 20₅

15: magnet sets 20₁, 20₆/magnet sets 20₂, 20₅/magnet sets 20₃, 20₄

Then, as illustrated in Table 3, there are 15 combinations of six magnet insertion holes 16₁ to 16₆ and six magnet sets 20₁ to 20₆ that can satisfy Condition 7, excluding a combination that is the same when the stacked rotor core 1 is turned upside down.

TABLE 3

| | | Magnet insertion hole | | | | | |
|---|---|---|---|---|---|---|---|
| | | 16₁ | 16₂ | 16₃ | 16₄ | 16₅ | 16₆ |
| Combination of magnet sets | 1 | 20₁ | 20₆ | 20₃ | 20₂ | 20₅ | 20₄ |
| | 2 | 20₁ | 20₆ | 20₃ | 20₂ | 20₄ | 20₅ |
| | 3 | 20₁ | 20₅ | 20₃ | 20₂ | 20₄ | 20₆ |
| | 4 | 20₁ | 20₆ | 20₂ | 20₃ | 20₅ | 20₄ |
| | 5 | 20₁ | 20₆ | 20₂ | 20₃ | 20₄ | 20₅ |
| | 6 | 20₁ | 20₅ | 20₂ | 20₃ | 20₄ | 20₆ |
| | 7 | 20₁ | 20₆ | 20₂ | 20₄ | 20₅ | 20₃ |
| | 8 | 20₁ | 20₆ | 20₂ | 20₄ | 20₃ | 20₅ |
| | 9 | 20₁ | 20₅ | 20₂ | 20₄ | 20₃ | 20₆ |
| | 10 | 20₁ | 20₆ | 20₂ | 20₅ | 20₄ | 20₃ |
| | 11 | 20₁ | 20₆ | 20₂ | 20₅ | 20₃ | 20₄ |
| | 12 | 20₁ | 20₄ | 20₂ | 20₅ | 20₃ | 20₆ |
| | 13 | 20₁ | 20₅ | 20₂ | 20₆ | 20₄ | 20₃ |
| | 14 | 20₁ | 20₅ | 20₂ | 20₆ | 20₃ | 20₄ |
| | 15 | 20₁ | 20₄ | 20₂ | 20₆ | 20₃ | 20₅ |

Alternatively, while Condition 7 is satisfied, the magnet sets 20₁ to 20₆ may be inserted in the magnet insertion holes 16₁ to 16₆ one by one such that a magnet set 20_{b} and a magnet set 20_{c} face each other with the center axis Ax interposed therebetween (Condition 8). As illustrated in the first section of Table 3, there is one combinations of six magnet insertion holes 16₁ to 16₆ and six magnet sets 20₁ to 20₆ that can satisfy Condition 8, excluding a combination that is the same when the stacked rotor core 1 is turned upside down (this is the same as the stacked rotor core 1 illustrated in FIG. 5C turned upside down).

Manufacturing Apparatus for Stacked Rotor Core

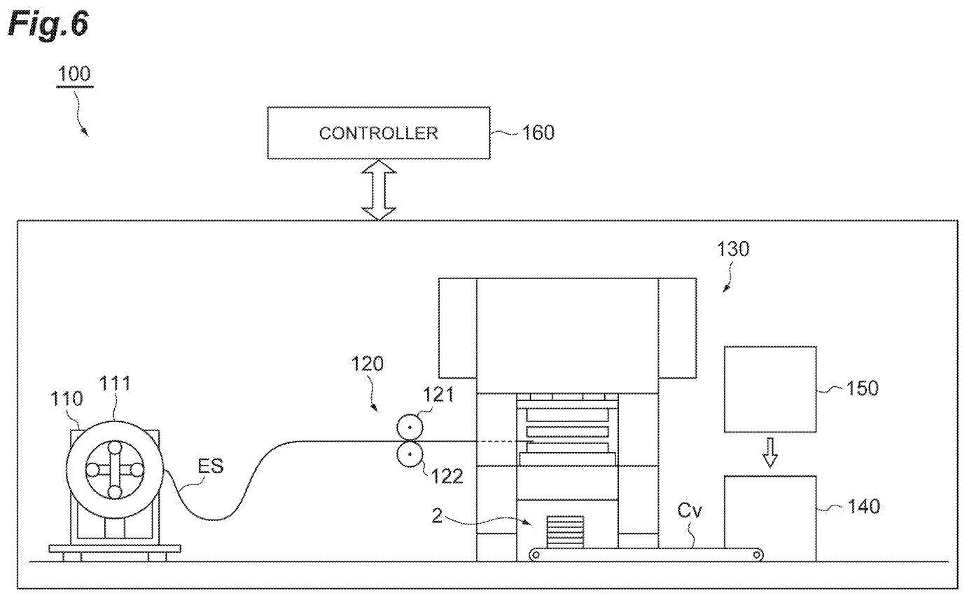

Referring now to FIG. 6, a manufacturing apparatus 100 for the stacked rotor core 1 is described.

The manufacturing apparatus 100 is an apparatus for manufacturing the stacked rotor core 1 from an electrical steel sheet ES (workpiece plate) which is a strip-like metal plate. The manufacturing apparatus 100 includes an uncoiler 110, a feeding device 120, a blanking device 130, a magnet attaching device 140, a magnet selecting device 150, and a controller 160 (control unit).

The uncoiler 110 rotatably holds a coil material 111 attached thereto. The coil material 111 is a strip-like electrical steel sheet ES wound into a coil shape. The feeding device 120 has a pair of rollers 121 and 122 sandwiching the electrical steel sheet ES from above and below. A pair of rollers 121 and 122 rotate and stop based on an instruction signal from the controller 160 and sequentially feed the electrical steel sheet ES toward the blanking device 130 intermittently.

The length of the electrical steel sheet ES that forms the coil material 111 may be, for example, about 500 m to 10000 m. The thickness of the electrical steel sheet ES may be, for example, about 0.1 mm to 0.5 mm The thickness of the electrical steel sheet ES may be, for example, about 0.1 mm to 0.3 mm in terms of obtaining the stacked rotor core 1 having more excellent magnetic characteristics. The width of the electrical steel sheet ES may be, for example, about 50 mm to 500 mm.

The blanking device 130 operates based on an instruction signal from the controller 160. The blanking device 130 has the function of sequentially blanking the electrical steel sheet ES intermittently fed by the feeding device 120 to form a blanked member W and the function of sequentially stacking the blanked members W obtained by blanking to produce a stack 10.

The stack 10 is discharged from the blanking device 130 and then placed onto a conveyor Cv extending between the blanking device 130 and the magnet attaching device 140. The conveyor Cv operates based on an instruction from the controller 160 and feeds the stack 10 to the magnet attaching device 140. The stack 10 may be conveyed by anything other than the conveyor Cv between the blanking device 130 and the magnet attaching device 140. For example, the stack 10 may be placed in a container and conveyed manually.

The magnet attaching device 140 operates based on an instruction signal from the controller 160. The magnet attaching device 140 has the function of performing the operation of inserting the magnet sets 20₁ to 20₆ obtained in the magnet selecting device 150 into the magnet insertion holes 16₁ to 16₆ in accordance with any one of Conditions 3 to 8, and the function of performing the operation of charging the resin material 14 into the magnet insertion holes 16₁ to 16₆ in which the magnet sets 20₁ to 20₆ have been inserted.

The magnet selecting device 150 operates based on an instruction signal from the controller 160. The magnet selecting device 150 has a weight meter and a robot hand not illustrated. The magnet selecting device 150 has the function of placing the permanent magnets 12₁ to 12₁₂ on the weight meter one by one using the robot hand so that the controller 160 obtains the individual weights of the permanent magnets 12₁ to 12₁₂, the function of determining combinations of the permanent magnets 12₁ to 12₁₂ by the controller 160 based on the obtained weights of the permanent magnets 12₁ to 12₁₂ in accordance with Condition 1 or 2, and the function of combining the permanent magnets 12₁ to 12₁₂ two by two based on the determined combinations to form magnet sets 20₁ to 20₆ by the robot hand.

The controller 160, for example, generates an instruction signal for operating each of the feeding device 120, the blanking device 130, the magnet attaching device 140, and the magnet selecting device 150, based on a program stored in a recording medium (not illustrated) or an operation input from an operator, and transmits the instruction signal to each of the feeding device 120, the blanking device 130, the magnet attaching device 140, and the magnet selecting device 150.

Method of Manufacturing Stacked Rotor Core

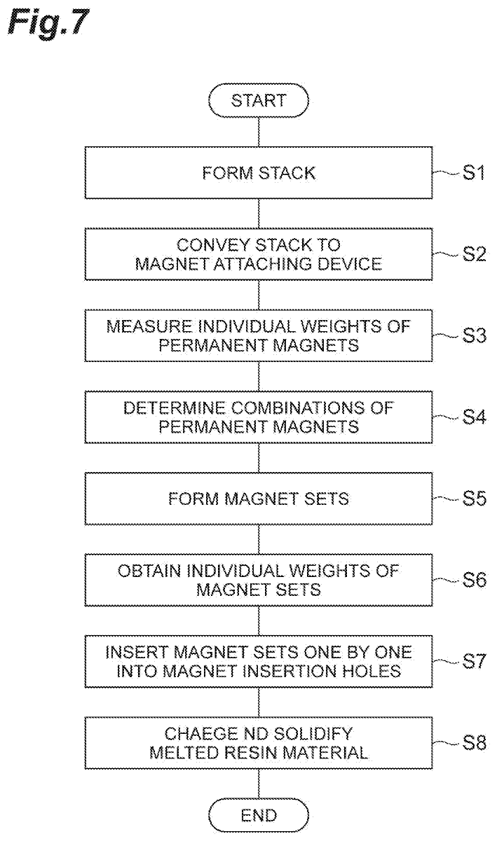

A method of manufacturing the stacked rotor core 1 will now be described with reference to FIG. 7. First of all, a stack 10 is formed (third step; see step S1 in FIG. 7). Specifically, the feeding device 120 feeds an electrical steel sheet ES to the blanking device 130 based on an instruction from the controller 160, and the blanking device 130 blanks a portion to be worked of the electrical steel sheet ES into a predetermined shape. A blanked member W is thus formed. This blanking process is repeated so that a predetermined number of blanked members W are stacked while being fastened to each other by connecting tab portions 18 to produce one stack 10.

Subsequently, the conveyor Cv conveys the stack 10 discharged from the blanking device 130 to the magnet attaching device 140, based on an instruction from the controller 160 (see step S2 in FIG. 7).

Before the stack 10 reaches the magnet attaching device 140, the magnet selecting device 150 performs operation based on an instruction from the controller 160. More specifically, the controller 160 controls the robot hand to place the permanent magnets 12₁ to 12₁₂ individually on a weight meter and receives data of the measured individual weights m₁ to m₁₂ of the permanent magnets 12₁ to 12₁₂ from the weight meter (first step; see step S3 in FIG. 7). Subsequently, the controller 160 determines combinations of permanent magnets 12₁ to 12₁₂ in accordance with Condition 1 or 2, based on the acquired individual weights m₁ to m₁₂ (see step S4 in FIG. 7). Subsequently, the controller 160 controls the robot hand to combine the permanent magnets 12₁ to 12₁₂ two by two based on the determined combinations and thereby form magnet sets 20₁ to 20₆ (second step; see step S5 in FIG. 7).

Here, the controller 160 may calculate the weights M₁ to M₆ of the magnet sets 20₁ to 20₆, based on data of the already measured individual weights m₁ to m₁₂ of the permanent magnets 12₁ to 12₁₂ (fifth step; see step S6 in FIG. 7). Alternatively, the controller 160 may control the robot hand to place the magnet sets 20₁ to 20₆ individually on the weight meter and receive data of the measured individual weights M₁ to M₆ of the magnet sets 20₁ to 20₆ from the weight meter (fifth step; see step S6 in FIG. 7). The controller 160 thereafter controls the robot hand to convey these magnet sets 20₁ to 20₆ to the magnet attaching device 140.

The controller 160 then controls the magnet attaching device 140 to insert the magnet sets 20₁ to 20₆ one by one into the magnet insertion holes 16₁ to 16₆ in accordance with any one of Conditions 3 to 8 (fourth step; see step S7 in FIG. 7). The controller 160 then instructs the magnet attaching device 140 to charge and solidify the resin material 14 in the melted state in each magnet insertion hole 16 (see step S8 in FIG. 7). In this way, the solidified resin material 14 fixes each magnet set 20 in the corresponding magnet insertion hole 16 and integrates the blanked members W adjacent in the stacking direction. The stacked rotor core 1 is thus obtained.

The process is thereafter followed by a shaft attaching step of inserting a shaft into the axial hole 10a and fixing the shaft to the stacked rotor core 1, for example, with a key, and an end plate attaching step of arranging end plates to both end surfaces of the stacked rotor core 1. The end plates may be fixed to the end surfaces of the stacked rotor core 1, for example, by connecting tabs, welding, bonding, or resin sealing, or may be fixed to the stacked rotor core 1 by screwing a nut into the shaft, or may be fixed to the shaft, for example, by a key. A rotor including the stacked rotor core 1, the shaft, and the end plates is thus obtained.

In the present example as described above, permanent magnets 12₁ to 12₁₂ are combined two by two in accordance with Condition 1 or 2 to form magnet sets 20₁ to 20₆. More specifically, in Condition 1, the magnet sets 20₁ to 20₆ are obtained by combining one relatively heavy permanent magnet 12 and one relatively light permanent magnet 12 of 12 permanent magnets 12₁ to 12₁₂ into one magnet set 20. With this configuration, the weights of the magnet sets 20₁ to 20₆ are equalized. Accordingly, with an extremely simple method of merely measuring the weight of each permanent magnet 12 to obtain a predetermined magnet set 20, the stacked rotor core 1 excellent in weight balance can be produced efficiently.

In Condition 2, the magnet sets 20₁ to 20₆ are obtained by repeatedly combining one heaviest permanent magnet 12 and one lightest permanent magnet 12 of 12 permanent magnets 12₁ to 12₁₂ into one magnet set 20. In this way, when two permanent magnets 12 are combined into one magnet set 20, the weights of the magnets set 20 are more equalized, so that the stacked rotor core 1 in even better weight balance can be obtained.

In the present example, the magnet sets 20₁ to 20₆ are attached in the magnet insertion holes 16₁ to 16₆ one by one in accordance with any one of Conditions 3 to 8. More specifically, in Condition 3, the magnet sets 20₁ to 20₆ are inserted one by one in any magnet insertion holes 16₁ to 16₆.

In Condition 4, when the weights M₁ to M₆ of the magnet sets 20₁ to 20₆ satisfy Expression (5), the magnet sets 20₁ to 20₆ are inserted in the magnet insertion holes 16₁ to 16₆ one by one such that a magnet set 20ₐ (a is a natural number from 2 to 5) is not adjacent to the magnet set 20ₐ₋₁ or the magnet set 20ₐ₊₁ in the circumferential direction of the center axis Ax. In this case, relatively heavy magnet sets 20 are not adjacent to each other in the circumferential direction or relatively light magnet sets 20 are not adjacent to each other in the circumferential direction, so that the weight balance of the stacked rotor core 1 as a whole is enhanced. Accordingly, the stacked rotor core 1 in even better weight balance can be obtained.

In Condition 5, when the weights M₁ to M₆ of the magnet sets 20₁ to 20₆ satisfy Expression (5), the magnet sets 20₁ to 20₆ are inserted in the magnet insertion holes 16₁ to 16₆ one by one such that a magnet set 20_{b} (b is an odd number from 1 to 6) and a magnet set 20_{c} (c is an even number that satisfies c=b+1 and from 1 to 6) face each other with the center axis Ax interposed therebetween. In this case, two magnet sets 20 having equivalent weights face each other with the center axis Ax interposed therebetween and therefore are attached to the magnet insertion holes 16 located farthest from each other. In this configuration, relatively heavy magnet sets 20 are less likely to gather in the circumferential direction or relatively light magnet sets 20 are less likely to gather in the circumferential direction, so that the weight balance of the stacked rotor core 1 is enhanced. Accordingly, the stacked rotor core 1 in even better weight balance can be obtained.

In Condition 7, when the weights M₁ to M₆ of the magnet sets 20₁ to 20₆ satisfy Expression (5), three pairs are each formed by selecting any two magnet sets 20 from among the magnet sets 20₁ to 20₆, and the magnet sets 20₁ to 20₆ are inserted in the magnet insertion holes 16₁ to 16₆ one by one such that relatively heavy magnet sets 20 of the pairs are not adjacent to each other in the circumferential direction of the center axis Ax, relatively light magnet sets 20 of the pairs are not adjacent to each other in the circumferential direction of the center axis Ax, and the magnet sets 20 in each pair face each other with the center axis Ax interposed therebetween. In this case, relatively heavy magnet sets 20 in pairs are not adjacent to each other in the circumferential direction of the center axis Ax or relatively light magnet sets 20 of the magnet sets 20 in pairs are not adjacent to each other in the circumferential direction of the center axis Ax, so that the weights of the magnet sets 20 are less likely to be unbalanced to one side in the circumferential direction. This configuration enhances the weight balance of the stacked rotor core 1. Accordingly, the stacked rotor core 1 in even better weight balance can be obtained.

In Condition 6, in addition to Condition 5, the odd-numbered magnet sets 20 of the magnet sets 20₁ to 20₆ are not adjacent to each other in the circumferential direction of the center axis Ax, and the even-numbered magnet sets 20 of the magnet sets 20₁ to 20₆ are not adjacent to each other in the circumferential direction of the center axis Ax. In Condition 8, in addition to Condition 7, the magnet set 20_{b} and the magnet set 20, face each other with the center axis Ax interposed therebetween. In these cases, heavy permanent magnets 12 or light permanent magnets 12 are less likely to be unbalanced to one side in the circumferential direction of the center axis Ax, so that the weight balance of the stacked rotor core 1 as a whole is enhanced. Accordingly, the stacked rotor core 1 in even better weight balance can be obtained.

It is to be understood that not all aspects, advantages and features described herein may necessarily be achieved by, or included in, any one particular example. Indeed, having described and illustrated various examples herein, it should be apparent that other examples may be modified in arrangement and detail may be omitted.

For example, in the foregoing example, two permanent magnets 12 are combined to form one magnet set 20. However, one magnet set 20 may be configured with a combination of three or more permanent magnets 12.

For example, when one magnet set 20 is configured with three permanent magnets 12, a plurality of magnet sets 20 may be obtained by repeatedly combining one relatively heavy permanent magnet 12, one relatively light permanent magnet 12, and any one permanent magnet 12 of a plurality of permanent magnets 12 into one magnet set 20. Alternatively, a plurality of magnet sets 20 may be obtained by repeatedly combining one heaviest permanent magnet 12, one lightest permanent magnet 12, and any one permanent magnet 12 of a plurality of permanent magnets 12 into one magnet set 20. In this case, the weights of the magnet sets 20 are more equalized, so that the stacked rotor core 1 in even better weight balance can be obtained. Even when one magnet set 20 is configured with five or more, odd number of permanent magnets 12, the permanent magnets 12 may be combined by a similar method as described above.

Alternatively, a plurality of magnet sets 20 may be obtained by repeatedly combining one relatively heavy permanent magnet 12, one relatively light permanent magnet 12, and one permanent magnet 12 having a weight indicating a median value of a plurality of permanent magnets 12 into one magnet set 20. Alternatively, a plurality of magnet sets 20 may be obtained by repeatedly combining one heaviest permanent magnet 12, one lightest permanent magnet 12, and one permanent magnet 12 having a weight indicating a median value of a plurality of permanent magnets 12 into one magnet set 20. In this case, the weights of the magnet sets 20 are even more equalized, so that a rotor core in even better weight balance can be obtained. Even when one magnet set 20 is configured with five or more, odd number of permanent magnets 12, the permanent magnets 12 may be combined by a similar method as described above.

When one magnet set 20 is configured with four permanent magnets 12, a plurality of magnet sets 20 may be obtained by repeatedly combining two relatively heavy permanent magnets 12 and two relatively light permanent magnets 12 of a plurality of permanent magnets 12 into one magnet set 20. Even when one magnet set 20 is configured with six or more, even number of permanent magnets 12, the permanent magnets 12 may be combined by a similar method as described above.

In the foregoing example, an example in which six magnet insertion holes 16 are formed in the stack 10 has mainly been described. However, a plurality of magnet insertion holes 16 may be formed in the stack 10. As will be described later, a plurality of magnet insertion holes 16 may be formed in the stack 10 similarly when one permanent magnet 12 is inserted in one magnet insertion hole 16.

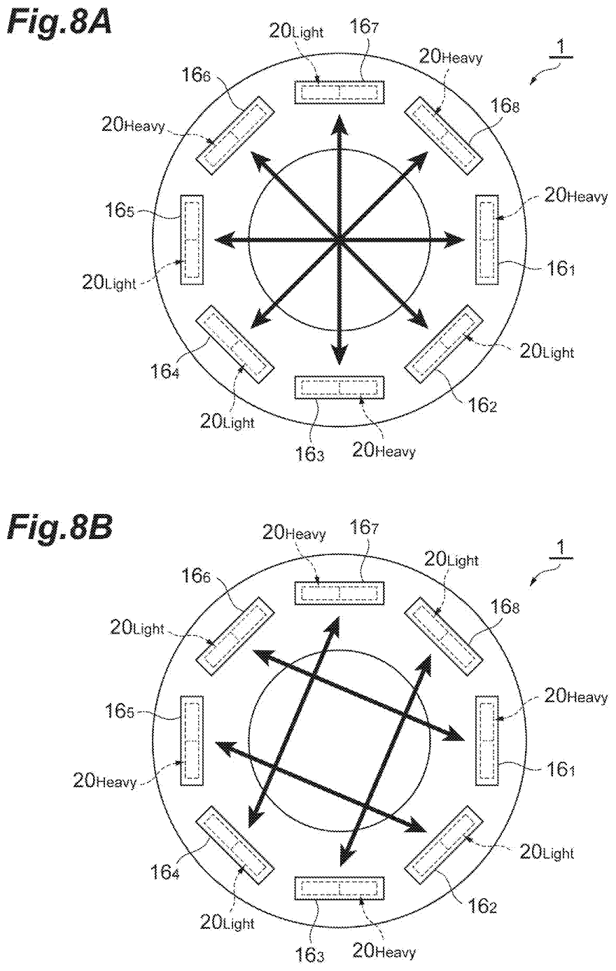

The definition in the present description of a pair of magnet sets 20 “facing each other with the center axis Ax interposed therebetween” will now be described with reference to a stack 10 in which eight magnet insertion holes 16₁ to 16₈ are formed. More specifically, in the present description, a pair of magnet sets 20 “facing each other with the center axis Ax interposed therebetween” refers to not only that a pair of magnet sets 20 are arranged on a straight line passing through the center axis Ax as illustrated in FIG. 8A but also that a pair of magnet sets 20 are not necessarily arranged on a straight line passing through the center axis Ax but a pair of magnet sets 20 and the center axis Ax are arranged side by side linearly to some extent as illustrated in FIG. 8B. Therefore, when a pair of a relatively heavy magnet set 20_{Heavy} and a relatively light magnet set 20_{Light} “face each other with the center axis Ax interposed therebetween” according to the former interpretation, as illustrated in FIG. 8A, relatively heavy magnet sets 20_{Heavy} are adjacent to each other in the circumferential direction or relatively light magnet sets 20_{Light} are adjacent to each other in the circumferential direction. On the other hand, when a pair of a relatively heavy magnet set 20_{Heavy} and a relatively light magnet set 20_{Light} “face each other with the center axis Ax interposed therebetween” according to the latter interpretation, as illustrated in FIG. 8B, a relatively heavy magnet set 20_{Heavy} and a relatively light magnet set 20_{Light} are alternately arranged in the circumferential direction (relatively heavy magnet sets 20_{Heavy} are not adjacent to each other in the circumferential direction or relatively light magnet sets 20_{Light} are not adjacent to each other in the circumferential direction).

The permanent magnets 12 may be inserted in the magnet insertion holes 16 one by one without forming magnet sets 20 as in the foregoing examples. Specifically, the stacked rotor core 1 may be formed through the steps of: acquiring the weights m₁ to m₆ of six permanent magnets 12₁ to 12₆ individually in the magnet selecting device 150; and when the acquired weights m₁ to m₆ of six permanent magnets 12₁ to 12₆ satisfy Expression (6), inserting these six permanent magnets 12₁ to 12₆ into six magnet insertion holes 16₁ to 16₆ one by one by the magnet attaching device 140 such that the d^{th} (d is a natural number from 2 to 5) permanent magnet 12_{d} is not adjacent to the (d−1)^{th} permanent magnet 12_{d-1} and the (d+1)^{th} permanent magnet 12_{d+1} in the circumferential direction of the center axis Ax (Condition 9).

m₁≥m₂≥ . . . m₅≥m₆ (6)

In this case, relatively heavy permanent magnets 12 are not adjacent to each other in the circumferential direction or relatively light permanent magnets 12 are not adjacent to each other in the circumferential direction. This configuration enhances the weight balance of the stacked rotor core 1 as a whole. Accordingly, with an extremely simple method of merely measuring the weight of each permanent magnet 12 and attaching the permanent magnet 12 to a predetermined magnet insertion hole 16, the stacked rotor core 1 excellent in weight balance can be produced efficiently.

Similarly, in a case where the first to L^{th} (L is a natural number equal to or greater than 5) permanent magnets 12 are present, when the weights m₁, m₂, . . . m_{L-1}, m_{L} of the first to L^{th} permanent magnets 12 satisfy Expression (7), the first to L^{th} permanent magnets 12₁ to 12_{L} may be inserted in the first to L^{th} magnet insertion holes 16₁ to 16_{L} one by one such that the d^{th} (d is a natural number from 2 to L−1) permanent magnet 12 is not adjacent to the (d−1)^{th} permanent magnet 12_{d-1} and the (d+1)^{th} permanent magnet 12_{d+1} in the circumferential direction of the center axis Ax.

m₁≥m₂≥ . . . m_{L-1}≥m_{L} (1)

Alternatively, the stacked rotor core 1 may be formed through the steps of: acquiring the weights m₁ to m₆ of six permanent magnets 12₁ to 12₆ individually in the magnet selecting device 150; and when the acquired weights m₁ to m₆ of six permanent magnets 12₁ to 12₆ satisfy Expression (6), inserting these six permanent magnets 12₁ to 12₆ into six magnet insertion holes 16₁ to 16₆ one by one by the magnet attaching device 140 such that the e^{th} (e is an odd number from 1 to 6) permanent magnet and the f^{th} (f is an even number that satisfies f=e+1 and from 1 to 6) permanent magnet face each other with the rotational axis interposed therebetween (Condition 10).

In this case, two permanent magnets 12 having equivalent weights face each other with the center axis Ax interposed therebetween and therefore are attached to the magnet insertion holes 16 located farthest from each other. In this configuration, relatively heavy permanent magnets 12 are less likely to gather in the circumferential direction or relatively light permanent magnets 12 are less likely to gather in the circumferential direction, so that the weight balance of the stacked rotor core 1 as a whole is enhanced. Accordingly, with an extremely simple method of merely measuring the weight of each permanent magnet 12 and attaching the permanent magnet 12 to a predetermined magnet insertion hole 16, the stacked rotor core 1 excellent in weight balance can be produced efficiently.

Similarly, in a case where the first to K^{th} (K is an even number equal to or greater than 4) permanent magnets 12 are present, when the weights m₁, m₂, . . . m_{K-1}, m_{K} of the first to K^{th} permanent magnets 12 satisfy Expression (8), the first to K^{th}permanent magnets 12₁ to 12_{K} may be inserted in the first to K^{th} magnet insertion holes 16₁ to 16_{K} one by one such that the e^{th} (e is an odd number from 1 to K) permanent magnet 12, and the f^{th} (f is an even number that satisfies f=e+1 and from 1 to K) permanent magnet 12_{f} face each other with the center axis Ax interposed therebetween. That is, the e^{th} permanent magnet 12ₑ and the f^{th} permanent magnet 12_{f} may form a pair so as to face each other with the center axis Ax interposed therebetween, and the weights m₁, m₂, . . . m_{K-1}, m_{K} of the first to K^{th} permanent magnets 12₁ to 12_{K} may decrease in this order. In this configuration, the odd-numbered permanent magnet 12 of each pair of permanent magnets 12 is heavier than the even-numbered permanent magnet 12 of the respective pair of permanent magnets 12.

m₁≥m₂≥ . . . m_{K-1}≥m_{K} (8)

In this case, odd-numbered permanent magnets 12 of the first to K^{th} permanent magnets 12₁ to 12_{K} are not necessarily adjacent to each other in the circumferential direction of the center axis Ax, and even-numbered permanent magnets 12 of the first to K^{th} permanent magnets 12₁ to 12_{K} are not necessarily adjacent to each other in the circumferential direction of the center axis Ax. With such a configuration, heavy permanent magnets 12 or light permanent magnets 12 are less likely to be unbalanced to one side in the circumferential direction of the center axis Ax, so that the weight balance of the stacked rotor core 1 as a whole is enhanced. Accordingly, the stacked rotor core 1 in even better weight balance can be obtained.

Alternatively, the stacked rotor core 1 may be formed through the steps of: acquiring the weights m₁ to m₆ of six permanent magnets 12₁ to 12₆ individually in the magnet selecting device 150; when the acquired weights m₁ to m₆ of six permanent magnets 12₁ to 12₆ satisfy Expression (6), forming three pairs each by selecting any two permanent magnets 12 from among the permanent magnets 12₁ to 12₆, and inserting these six permanent magnets 12₁ to 12₆ into six magnet insertion holes 16₁ to 16₆ one by one by the magnet attaching device 140 such that relatively heavy permanent magnets 12 of the pairs are not adjacent to each other in the circumferential direction of the center axis Ax, relatively light permanent magnets 12 of the pairs are not adjacent to each other in the circumferential direction of the center axis Ax, and the permanent magnets 12 in each pair face each other with the center axis Ax interposed therebetween (Condition 11).

In this case, the weights of the permanent magnets 12 are less likely to be unbalanced to one side in the circumferential direction of the center axis Ax, so that the weight balance of the stacked rotor core 1 as a whole is enhanced. Accordingly, with an extremely simple method of merely measuring the weight of each permanent magnet 12 and attaching the permanent magnet 12 to a predetermined magnet insertion hole 16, the stacked rotor core 1 excellent in weight balance can be produced efficiently.

Similarly, in a case where the first to J^{th} (J is an even number equal to or greater than 6) permanent magnets 12 are present, when the weights m₁, m₂, . . . m_{J-1}, m_{J} of the first to J^{th} permanent magnets 12 satisfy Expression (9), J/2 pairs may be each formed by selecting any two permanent magnets from among the first to J^{th} permanent magnets, and the first to J^{th} permanent magnets may be inserted into the first to J^{th} magnet insertion holes 16₁ to 16_{J} one by one such that relatively heavy permanent magnets of the pairs are not adjacent to each other in the circumferential direction of the rotational axis, relatively light permanent magnets of the pairs are not adjacent to each other in the circumferential direction of the rotational axis, and the permanent magnets in each pair face each other with the rotational axis interposed therebetween.

m₁≥m₂≥ . . . m_{J-1}≥m_{J} (9)

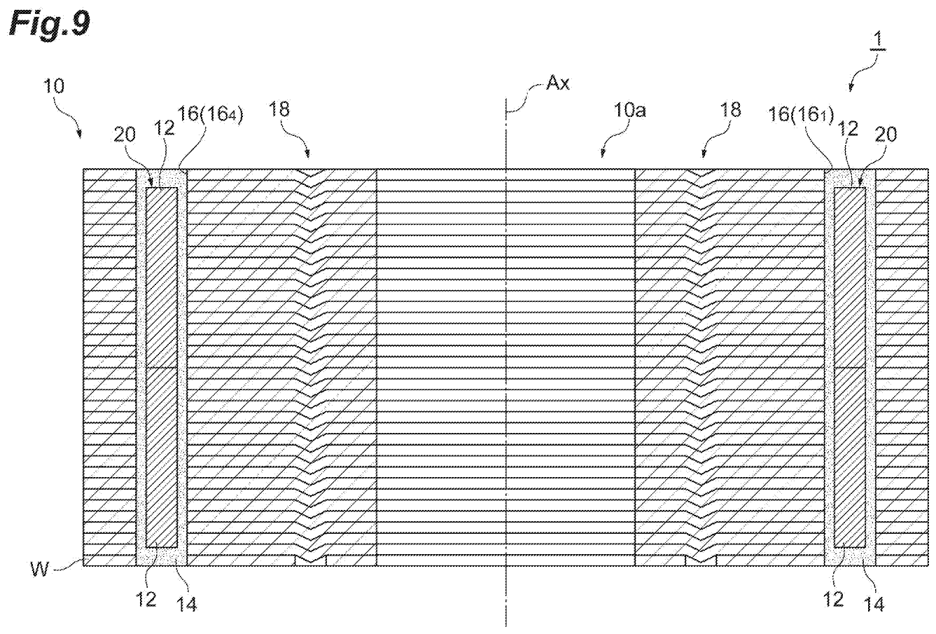

As illustrated in FIG. 9, a plurality of permanent magnets 12 may be arranged in a row in one magnet insertion hole 16 so as to be adjacent to each other in its extending direction (stacking direction). Alternatively, in one magnet insertion hole 16, a plurality of permanent magnets 12 may be arranged in a row in the longitudinal direction of the magnet insertion hole 16 and a plurality of permanent magnets 12 may be arranged in a row in the extending direction of the magnet insertion hole 16 (stacking direction).

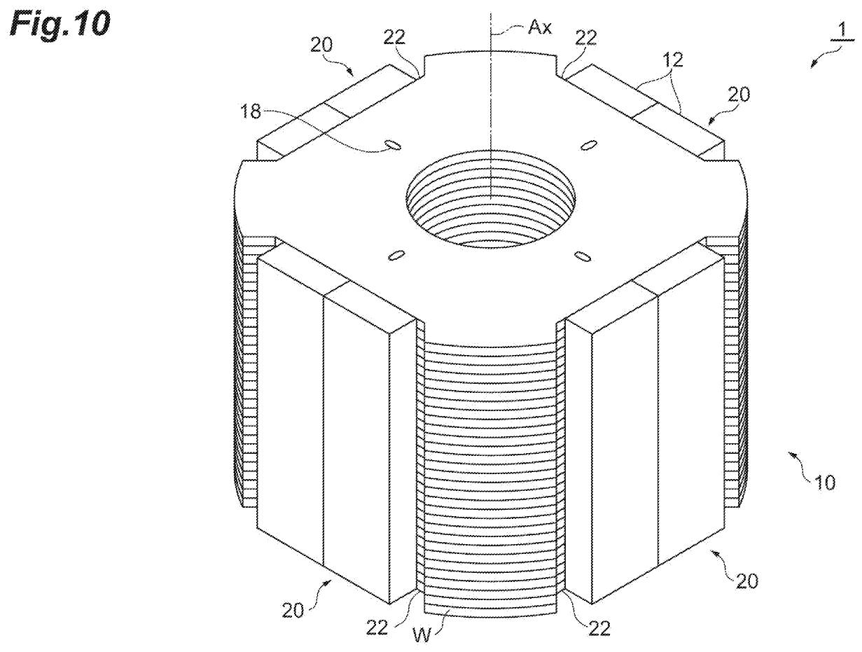

As illustrated in FIG. 10, the scope and gist of the claims can be applied to the stacked rotor core 1 for use in a surface permanent magnet (SPM) motor. In this case, the outer peripheral surface of the stack 10 has depressed grooves 22 (attaching location) each extending in the center axis Ax direction, and one magnet set 20 is attached to each depressed groove 22.

In the foregoing example, the stack 10 formed by stacking a plurality of blanked members W functions as a core body to which permanent magnets 12 are attached. However, the core body may be configured with anything other than the stack 10. Specifically, the core body may be, for example, a compact (compression molding) of ferromagnetic powder or may be formed by injection-molding a resin material containing ferromagnetic powder.

The operation in the magnet attaching device 140 or the magnet selecting device 150 may be performed manually by a worker.

An example method of manufacturing a rotor core may include: acquiring the weights of a plurality of permanent magnets individually; obtaining first to N^{th} (N is a natural number equal to or greater than 2) magnet sets by combining at least one relatively heavy permanent magnet and at least one relatively light permanent magnet of the permanent magnets into one magnet set, based on the acquired individual weights of the permanent magnets; preparing a core body configured to rotate around a predetermined rotational axis, the core body having first to N^{th} attaching locations arranged in a row in a circumferential direction of the rotational axis; and attaching the first to N^{th} magnet sets to any of the first to N^{th} attaching locations one by one.

In this case, the first to N^{th} (N is a natural number equal to or greater than 2) magnet sets are obtained by combining at least one relatively heavy permanent magnet and at least one relatively light permanent magnet of a plurality of permanent magnets into one magnet set. With this configuration, the weights of the magnet sets are equalized. Accordingly, with an extremely simple method of merely measuring the weight of each permanent magnet to obtain a predetermined magnet set, a rotor core excellent in weight balance can be produced efficiently.

In some examples, obtaining first to N^{th} magnet sets may include repeatedly combining one heaviest permanent magnet and one lightest permanent magnet of the permanent magnets into one magnet set. In this way, when two permanent magnets are combined into one magnet set, the weights of the magnet sets are more equalized, so that a rotor core in even better weight balance can be obtained.

In some examples, obtaining first to N^{th} magnet sets may include repeatedly combining one heaviest permanent magnet, one lightest permanent magnet, and any one permanent magnet of the permanent magnets into one magnet set. In this way, when three permanent magnets are combined into one magnet set, the weights of the magnet sets are more equalized, so that a rotor core in even better weight balance can be obtained.

In some examples, obtaining first to N^{th} magnet sets may include repeatedly combining one heaviest permanent magnet, one lightest permanent magnet, and one permanent magnet having a weight indicating a median value of the permanent magnets into one magnet set. In this way, when three permanent magnets are combined into one magnet set, the weights of the magnet sets are even more equalized, so that a rotor core in even better weight balance can be obtained.

An example method may further include acquiring the weights of the first to N^{th} magnet sets individually before attaching the first to N^{th} magnet sets one by one. When the acquired weights M₁, M₂, . . . M_{N-1}, M_{N} of the first to N^{th} magnet sets satisfy Expression (10), attaching the first to N^{th} magnet sets one by one may include attaching the first to N^{th} magnet sets to the first to N^{th} attaching locations one by one such that the a^{th} (a is a natural number from 2 to N−1) magnet set of the first to N^{th} magnet sets is not adjacent to the (a−1)^{th} magnet set of the first to N^{th} magnet sets and the (a+1)^{th} magnet set of the first to N^{th} magnet sets in the circumferential direction of the rotational axis.

M₁≥M₂≥ . . . M_{N-1}≥M_{N} (10)

In this case, relatively heavy magnet sets are not adjacent to each other in the circumferential direction or relatively light magnet sets are not adjacent to each other in the circumferential direction, so that the weight balance of the rotor core as a whole is enhanced. Accordingly, a rotor core in even better weight balance can be obtained.

An example method may further include acquiring the weights of the first to N^{th} magnet sets individually before attaching the first to N^{th} magnet sets one by one. When the acquired weights M₁, M₂, . . . M_{N-1}, M_{N} of the first to N^{th} magnet sets satisfy Expression (11), attaching the first to N^{th} magnet sets one by one may include attaching the first to N^{th} magnet sets to the first to N^{th} attaching locations one by one such that the b^{th} (b is an odd number from 1 to N) magnet set of the first to N^{th} magnet sets and the c^{th} (c is an even number that satisfies c=b+1 and from 1 to N) magnet set of the first to N^{th} magnet sets face each other with the rotational axis interposed therebetween.

M₁≥M₂≥ . . . M_{N-1}≥M_{N} (11)

In this case, two magnet sets having equivalent weights face each other with the rotational axis interposed therebetween and therefore are attached to the attaching locations located farthest from each other. In this configuration, relatively heavy magnet sets are less likely to gather in the circumferential direction or relatively light magnet sets are less likely to gather in the circumferential direction, so that the weight balance of the rotor core is enhanced. Accordingly, a rotor core in even better weight balance can be obtained.

In some examples, attaching the first to N^{th} magnet sets one by one may include attaching the first to N^{th} magnet sets to the first to N^{th} attaching locations one by one such that odd-numbered magnet sets of the first to N^{th} magnet sets are not adjacent to each other in the circumferential direction of the rotational axis and even-numbered magnet sets of the first to N^{th} magnet sets are not adjacent to each other in the circumferential direction of the rotational axis. The b^{th} magnet set and the c^{th} magnet set form a pair so as to face each other with the rotational axis interposed therebetween, and the weights of the first to N^{th} magnet sets decrease in this order according to Expression (10). In this configuration, the odd-numbered magnet set of a pair of magnet sets is heavier than the even-numbered magnet set of the pair of magnet sets. In this case, when the first to N^{th} magnet sets are attached to the first to N^{th} attaching locations one by one, heavy magnet sets are less likely to be unbalanced to one side in the circumferential direction of the rotational axis or light magnet sets are less likely to be unbalanced to one side in the circumferential direction of the rotational axis, so that the weight balance of the rotor core as a whole is enhanced. Accordingly, a rotor core in even better weight balance can be obtained.

An example method may further include acquiring the weights of the first to N^{th} magnet sets individually before attaching the first to N^{th} magnet sets one by one. Obtaining first to N^{th} magnet sets may include obtaining first to N^{th} (N is a natural number equal to or greater than 6) magnet sets by combining at least one relatively heavy permanent magnet and at least one relatively light permanent magnet of the permanent magnets into one magnet set. Attaching the first to N^{th} magnet sets one by one may include, when the acquired weights M₁, M₂, . . . M_{N-1}, M_{N} of the first to N^{th} magnet sets satisfy Expression (12), forming N/2 pairs each by selecting any two magnet sets from among the first to N^{th} magnet sets, and attaching the first to N^{th} magnet sets to the first to N^{th} attaching locations one by one such that relatively heavy magnet sets of the pairs are not adjacent to each other in the circumferential direction of the rotational axis, relatively light magnet sets of the pairs are not adjacent to each other in the circumferential direction of the rotational axis, and the magnet sets in each pair face each other with the rotational axis interposed therebetween.

M₁≥M₂≥ . . . M_{N-1}≥M_{N} (12)

In this case, relatively heavy magnet sets are not adjacent to each other in the circumferential direction of the rotational axis or relatively light magnet sets of the magnet sets in pairs are not adjacent to each other in the circumferential direction of the rotational axis, so that the weights of the magnet sets are less likely to be unbalanced to one side in the circumferential direction. This configuration enhances the weight balance of the rotor core as a whole. Accordingly, a rotor core in even better weight balance can be obtained.

Another example method of manufacturing a rotor core may include: acquiring the weights of first to L^{th} (L is a natural number equal to or greater than 5) permanent magnets individually; preparing a core body configured to rotate around a predetermined rotational axis, the core body having first to L^{th} attaching locations arranged in a row in a circumferential direction of the rotational axis; and when the acquired weights m₁, m₂, . . . m_{L-1}, m_{L} of the first to L^{th} permanent magnets satisfy Expression (13), attaching the first to L^{th} permanent magnets to the first to L^{th} attaching locations one by one such that the d^{th} (d is a natural number from 2 to L−1) permanent magnet of the first to L^{th} permanent magnets is not adjacent to the (d−1)^{th} permanent magnet of the first to L^{th} permanent magnets and the (d+1)^{th} permanent magnet of the first to L^{th} permanent magnets in the circumferential direction of the rotational axis.

m₁≥m₂≥ . . . m_{L-1}≥m_{L} (1)

In this case, the permanent magnets are attached to the attaching locations one by one in accordance with the acquired individual weights of the permanent magnets. Specifically, relatively heavy permanent magnets are not adjacent to each other in the circumferential direction or relatively light permanent magnets are not adjacent to each other in the circumferential direction. This configuration enhances the weight balance of the rotor core as a whole. Accordingly, with an extremely simple method of merely measuring the weight of each permanent magnet and attaching the permanent magnet to a predetermined attaching location, a rotor core excellent in weight balance can be produced efficiently.

Still another example method of manufacturing a rotor core may include: acquiring the weights of first to K^{th} (K is an even number equal to or greater than 4) permanent magnets individually; preparing a core body configured to rotate around a predetermined rotational axis, the core body having first to K^{th} attaching locations arranged in a row in a circumferential direction of the rotational axis; and when the acquired weights m₁, m₂, . . . m_{K-1}, m_{K} of the first to K^{th} permanent magnets satisfy Expression (14), attaching the first to K^{th} permanent magnets to the first to K^{th} attaching locations one by one such that the e^{th} (e is an odd number from 1 to K) permanent magnet of the first to K^{th} permanent magnets and the f^{th} (f is an even number that satisfies f=e+1 and from 1 to K) permanent magnet of the first to K^{th} permanent magnets face each other with the rotational axis interposed therebetween.

m₁≥m₂≥ . . . m_{K-1}≥m_{K} (14)

In this case, the permanent magnets are attached to the attaching locations one by one in accordance with the acquired individual weights of the permanent magnets. Specifically, two permanent magnets having equivalent weights face each other with the rotational axis interposed therebetween and therefore are attached to the attaching location located farthest from each other. In this configuration, relatively heavy permanent magnets are less likely to gather in the circumferential direction or relatively light permanent magnets are less likely to gather in the circumferential direction, so that the weight balance of the rotor core as a whole is enhanced. Accordingly, with an extremely simple method of merely measuring the weight of each permanent magnet and attaching the permanent magnet to a predetermined attaching location, a rotor core excellent in weight balance can be produced efficiently.

In some examples, attaching the first to K^{th} permanent magnets one by one may include attaching the first to K^{th} permanent magnets to the first to K^{th} attaching locations one by one such that odd-numbered permanent magnets of the first to K^{th} permanent magnets are not adjacent to each other in the circumferential direction of the rotational axis and even-numbered permanent magnets of the first to K^{th} permanent magnets are not adjacent to each other in the circumferential direction of the rotational axis. The e^{th} permanent magnet and the f^{th} permanent magnet form a pair so as to face each other with the rotational axis interposed therebetween, and the weights of the first to K^{th} permanent magnets decrease in this order according to Expression (12). In this configuration, the odd-numbered permanent magnet of each pair of permanent magnets is heavier than the even-numbered permanent magnet of the respective pair of permanent magnets. In this case, when the first to K^{th} permanent magnets are attached to the first to N^{th} attaching locations one by one, heavy permanent magnets are less likely to be unbalanced to one side in the circumferential direction of the rotational axis or light permanent magnets are less likely to be unbalanced to one side in the circumferential direction of the rotational axis, so that the weight balance of the rotor core as a whole is enhanced. Accordingly, a rotor core in even better weight balance can be obtained.

Further, another example method of manufacturing a rotor core may include: acquiring the weights of first to J^{th} (J is an even number equal to or greater than 6) permanent magnets individually; preparing a core body configured to rotate around a predetermined rotational axis, the core body having first to J^{th} attaching locations arranged in a row in a circumferential direction of the rotational axis; and when the acquired weights m₁, m₂, . . . m_{J-1}, m_{J} of the first to J^{th} permanent magnets satisfy Expression (15), forming J/2 pairs each by selecting any two permanent magnets from among the first to J^{th} permanent magnets, and attaching the first to J^{th} permanent magnets to the first to J^{th} attaching locations one by one such that relatively heavy permanent magnets of the pairs are not adjacent to each other in the circumferential direction of the rotational axis, relatively light permanent magnets of the pairs are not adjacent to each other in the circumferential direction of the rotational axis, and the permanent magnets in each pair face each other with the rotational axis interposed therebetween.

m₁≥m₂≥ . . . m_{J-1}≥m_{J} (15)

In some examples, the permanent magnets are attached to the attaching locations one by one in accordance with the acquired individual weights of the permanent magnets. Specifically, the permanent magnets are attached to the attaching locations one by one such that relatively heavy permanent magnets are not adjacent to each other in the circumferential direction of the rotational axis or relatively light permanent magnets of the pairs of magnet sets are not adjacent to each other in the circumferential direction of the rotational axis. With this configuration, the weights of permanent magnets are less likely to be unbalanced to one side in the circumferential direction, so that the weight balance of the rotor core as a whole is enhanced. Accordingly, with an extremely simple method of merely measuring the weight of each permanent magnet and attaching the permanent magnet to a predetermined attaching location, a rotor core excellent in weight balance can be produced efficiently.

We claim all modifications and variations coming within the spirit and scope of the subject matter claimed herein.

1. A method of manufacturing a rotor core comprising:
acquiring individual weights of a plurality of permanent magnets to identify heavier permanent magnets and lighter permanent magnets based on a comparison of the individual weights;
obtaining first to N^{th} magnet sets by combining at least one of the heavier permanent magnets and at least one of the lighter permanent magnets into each magnet set, wherein N is a natural number equal to or greater than 2;
preparing a core body configured to rotate around a predetermined rotational axis, the core body comprising first to N^{th} attaching locations arranged in a circumferential direction of the rotational axis; and
attaching each of the first to N^{th} magnet sets to a different one of the first to N^{th} attaching locations.

2. The method according to claim 1, wherein obtaining the first to N^{th} magnet sets includes:
categorizing the individual weights for the plurality of magnets from lightest permanent magnet to heaviest permanent magnet;
combining the heaviest permanent magnet with the lightest permanent magnet to obtain the first magnet set;
selecting a next lightest permanent magnet and a next heaviest permanent magnet; and
repeatedly combining the next heaviest permanent magnet and the next lightest permanent magnet to obtain N magnet sets.

3. The method according to claim 1, wherein obtaining the first to N^{th} magnet sets includes repeatedly combining one of the heavier permanent magnets, one of the lighter permanent magnets, and a third permanent magnet into each magnet set.

4. The method according to claim 3, wherein the third permanent magnet has a weight indicating a median value of the individual weights.

5. The method according to claim 1,
wherein the individual weights of the first to N^{th} magnet sets are acquired before attaching the first to N^{th} magnet sets to the first to N^{th} attaching locations, and
wherein when acquired weights M₁, M₂, . . . M_{N-1}, M_{N} of the first to N^{th} magnet sets satisfy the expression
M₁≥M₂≥ . . . M_{N-1}≥M_{N}
the first to N^{th} magnet sets are attached one by one to the first to N^{th} attaching locations such that an a^{th} magnet set of the first to N^{th} magnet sets is not adjacent to an (a−1)^{th} magnet set of the first to N^{th} magnet sets in the circumferential direction of the rotational axis, and the a^{th} magnet set is also not adjacent to an (a+1)^{th} magnet set of the first to N^{th} magnet sets in the circumferential direction of the rotational axis, wherein a is a natural number from 2 to N−1.

6. The method according to claim 1,
wherein the individual weights of the first to N^{th} magnet sets are individually acquired before attaching the first to N^{th} magnet sets to the first to N^{th} attaching locations, and
wherein when the acquired weights M₁, M₂, . . . M_{N-1}, M_{N} of the first to N^{th} magnet sets satisfy the expression
M₁≥M₂≥ . . . M_{N-1}≥M_{N} (1)
the first to N^{th} magnet sets are attached one by one to the first to N^{th} attaching locations such that a b^{th} magnet set of the first to N^{th} magnet sets and a c^{th} magnet set of the first to N^{th} magnet sets face each other with the rotational axis interposed therebetween, wherein b is an odd number from 1 to N, and wherein c is an even number from 2 to N that satisfies c=b+1.

7. The method according to claim 6, wherein the first to N^{th} magnet sets are individually attached to the first to N^{th} attaching locations such that odd-numbered magnet sets of the first to N^{th} magnet sets are not adjacent to each other in the circumferential direction of the rotational axis, and such that even-numbered magnet sets of the first to N^{th} magnet sets are not adjacent to each other in the circumferential direction of the rotational axis.

8. The method according to claim 1,
wherein the individual weights of the first to N^{th} magnet sets are individually acquired before attaching the first to N^{th} magnet sets to the first to N^{th} attaching locations,
wherein obtaining the first to N^{th} magnet sets includes obtaining the first to N^{th} magnet sets by combining at least one relatively heavy permanent magnet and at least one relatively light permanent magnet of the permanent magnets into one magnet set, wherein N is a natural number equal to or greater than 6,
wherein the first to N^{th} magnet sets are attached to the first to N^{th} attaching locations when the acquired weights M₁, M₂, . . . M _{N-1}, M_{N} of the first to N^{th} magnet sets satisfy the expression
M₁≥M₂≥ . . . M_{N-1}≥M_{N}, and
wherein attaching the first to N^{th} magnet sets to the first to N^{th} attaching locations includes:
categorizing the magnet sets as comprising lighter magnet sets and heavier magnet sets,
forming N/2 magnet pairs each by selecting different combinations of two magnet sets from among the lighter magnet sets and the heavier magnet sets, and
attaching the first to N^{th} magnet sets to the first to N^{th} attaching locations one by one such that the heavier magnet sets of the magnet pairs are not adjacent to each other in the circumferential direction of the rotational axis, the lighter magnet sets of the magnet pairs are not adjacent to each other in the circumferential direction of the rotational axis, and the magnet sets in each magnet pair face each other with the rotational axis interposed therebetween.

9. A method of manufacturing a rotor core comprising:
acquiring individual weights of first to L^{th} permanent magnets, wherein L is a natural number equal to or greater than 5;
preparing a core body configured to rotate around a predetermined rotational axis, the core body comprising first to L^{th} attaching locations arranged in a circumferential direction of the rotational axis; and
when acquired weights m₁, m₂, . . . m_{L-1}, m_{L} of the first to L^{th} permanent magnets satisfy the expression
m₁≥m₂≥ . . . m_{L-1}≥m_{L}
the first to L^{th} permanent magnets are attached one by one to the first to L^{th} attaching locations such that a d^{th} permanent magnet of the first to L^{th} permanent magnets is not adjacent to a (d−1)^{th} permanent magnet of the first to L^{th} permanent magnets in the circumferential direction of the rotational axis, and the d^{th} permanent magnet is also not adjacent to a (d+1)^{th} permanent magnet of the first to L^{th} permanent magnets in the circumferential direction of the rotational axis, wherein d is a natural number from 2 to L−1.

10. A method of manufacturing a rotor core comprising:
acquiring individual weights of first to K^{th} permanent magnets, wherein K is an even number equal to or greater than 4;
preparing a core body configured to rotate around a predetermined rotational axis, the core body comprising first to K^{th} attaching locations arranged in a circumferential direction of the rotational axis; and
when acquired weights m₁, m₂, . . . m_{K-1}, m_{K} of the first to K^{th} permanent magnets satisfy the expression
m₁≥m₂≥ . . . m_{K-1}≥m_{K}
the first to K^{th} permanent magnets are attached one by one to the first to K^{th} attaching locations such that an e^{th}) permanent magnet of the first to K^{th} permanent magnets and a f^{th} permanent magnet of the first to K^{th} permanent magnets face each other with the rotational axis interposed therebetween, wherein e is an odd number from 1 to K, and wherein f is an even number from 1 to K that satisfies the expression f=e+1.

11. The method according to claim 10, wherein the first to K^{th} permanent magnets are attached one by one to the first to K^{th} attaching locations such that odd-numbered permanent magnets of the first to K^{th} permanent magnets are not adjacent to each other in the circumferential direction of the rotational axis, and even-numbered permanent magnets of the first to K^{th} permanent magnets are not adjacent to each other in the circumferential direction of the rotational axis.

12. A method of manufacturing a rotor core comprising:
acquiring individual weights of first to J^{th} permanent magnets, wherein J is an even number equal to or greater than 6;
preparing a core body configured to rotate around a predetermined rotational axis, the core body comprising first to J^{th} attaching locations arranged in a circumferential direction of the rotational axis; and
attaching the first to J^{h} permanent magnets to the first to J^{th} attaching locations when the acquired weights m₁, m₂, . . . m_{J-1}, m_{J} of the first to J^{th} permanent magnets satisfy the expression
m₁≥m₂≥ . . . m_{J-1}≥m_{J},
wherein attaching the first to J^{th} permanent magnets to the first to J^{th} attaching locations includes:
categorizing permanent magnets as comprising lighter permanent magnets and heavier permanent magnets,
forming J/2 magnet pairs each by selecting different combinations of two permanent magnets from among the lighter permanent magnets and the heavier permanent magnets, and
attaching the first to J^{th} permanent magnets to the first to J^{th} attaching locations one by one such that the heavier permanent magnets of the magnet pairs are not adjacent to each other in the circumferential direction of the rotational axis, the lighter permanent magnets of the pairs are not adjacent to each other in the circumferential direction of the rotational axis, and the permanent magnets in each magnet pair face each other with the rotational axis interposed therebetween.
